(19) United States
(12) Patent Application Publication
(10) Pub. No.: US 2008/0281714 A1
(43) Pub. Date: Nov. 13, 2008

(54) SYSTEM AND METHOD FOR DETERMINING A PRICE OF GOODS

(76) Inventor: Scott E. Kluth, Streamwood, IL (US)

Correspondence Address: Mathew R.P. Perrone, Jr.;Brie A. Crawford, 210 South Main Street, Algonquin, IL, 60102, US

(21) Appl. No.: 11/746,471

(22) Filed: May 9, 2007

(51) Int. Cl. G06Q 30/00

(52) U.S. Cl. 705/26

(57) ABSTRACT

A coupon integrator has a method for entering a desired product search term, a price comparison database which searches for online stores carrying a particular product and the pre coupon prices, a coupon database which identifies any available coupons, and a price calculator database which calculates the discount price based on the pre coupon price and any available coupons. Further optional embodiments include a product availability database which identifies whether a product is currently available at a merchant. A merchant database calculates the shipping, handling, and tax fees for a product for a specific zip code and a shipping charge and tax calculator database calculates the final cost by factoring in the discount price, the shipping and handling fee, any available shipping coupons, and the tax.

This invention relates to a system and method for determining the price of goods purchased online and more particularly to a system and method for determining a price of goods purchased online, by factoring in the stated price and assorted discounts or coupons, in order to achieve the most desired price.

### BACKGROUND OF THE INVENTION

Online shopping has become an increasingly popular method of purchasing a desired product in recent years and has become a lucrative outlet for merchants to sell their goods. Online retailers routinely use online coupons as a method of attracting potential customers to their product or website, browsing their online catalogs, and enticing these customers to purchase their product. These methods benefit all parties in that merchants increase their sales and profit, while customers obtain the desired product with greater savings. However, in order for potential customers to utilize these coupons and the potential benefits, they have to know that the coupon exists for a particular merchant selling a particular product. This task requires a quick and efficient manner of accessing and utilizing these online coupons.

In order for a potential consumer to determine if the coupon makes the desired product a good deal, the consumer has to be able to compare the price of the product at other merchants with other coupons. Many online merchants sell the exact product the consumer desires at a variety of prices. To make an informed decision, the consumer must be able to compare both the pre coupon price and the post coupon price for the merchant for which the coupon is offered against the same product, which is offered in another competitive merchant.

In addition, some online merchants base the coupon discount on the total purchase price of the customer's order. For example, if the online customer spends fifty ($50.00) dollars or more, that customer will receive a five-dollar discount, and if that customer spends $100.00 or more, the customer receives a ten-dollar discount under a similar analysis. Therefore, the post coupon purchase price of the desired product will vary according to how much the customer spends on a particular order. A system which provides the customer access to all of this information in a neat and organized manner will be extremely useful.

Furthermore, if the coupon has a limited time for which it is valid, it is important for the consumer to know if the item is available while the coupon is still applicable. A system in which the consumer can compare pre coupon and post coupon prices at competing online merchants and the availability status of the product at these merchants will be a useful invention.

Moreover, while the coupon may reduce the purchase price, the shipping and handling charges may sometimes also need to be considered. While the coupon may make the product less expensive at a specific merchant, the product still may be a better deal or obtainable at a lower price from another merchant once shipping and handling charges are considered. At many merchants, shipping may be free or discounted, which also needs to be factored into the consideration. Thus, a system which will factor in the shipping and handling charge, with any shipping discounts, for a particular merchant will be a useful improvement in the art.

A system which will allow a consumer to search or—categorically drill down for a merchant selling a desired product, the pre coupon price of the product, any coupons available at the merchant for a desired product, and the post coupon price of a product in a fast, convenient, and user-friendly method will be useful to online shoppers.

To find a product online search or browse is used. Search involves looking for a particular product. A consumer performs a search to find coupons or information on a particular product such as a digital camera.

In contrast, browse involves having general idea of the subject and then categorically drilling down to find a particular product. The consumer categorically drills down by clicking on a series of categories and subcategories provided by a particular website until the desired product is found. Such drilling down to a desired area is sometimes called browsing. For example, the consumer browses electronics by clicking on the general category of electronics. Then, the consumer categorically-drills down by clicking on the subcategory of cameras then clicking on the second subcategory of digital cameras.

### SUMMARY OF THE INVENTION

Among the many objectives of this invention is the provision of a coupon integrator which allows the user to compare pre coupon prices of a desired product at a variety of online merchants.

A further objective of this invention is the provision of a system which allows customers a way to search or categorically drill down for coupons for online retailers selling a desired product.

A still further objective of this invention is the provision of a system which determines whether a desired product is available through a specific online retailer while a specific coupon is valid.

A still further objective of this invention is to provide a coupon integrator that is user friendly.

Also, a further objective of this invention is to provide a system which is quick and efficient.

Moreover, a further objective of this invention is to provide a system which returns the pre coupon and post coupon price information in an organized format.

A still further objective of this invention is to provide a coupon integrator, which provides a final, post coupon price after factoring in varying initial, pre coupon selling prices and savings realized by the consumer.

Also, a further objective of this invention is to provide a coupon integrator which accounts for coupons which base the amount of the discount on the total purchase price of the customer's order.

Another objective of this invention is to provide an optional model of the coupon integrator which calculates the shipping and handling charge and taxes into the post coupon price.

Moreover, another objective of this invention is to provide an optional model of the coupon integrator which calculates any shipping and handling discount coupons into the post coupon price.

These and other objectives of the invention (which other objectives become clear by consideration of the specification, claims and drawings as a whole) are met by providing a coupon integrator in the form of a database search engine which allows the consumer to search or categorically drill down a product, submit this product to a price comparison database, a coupon database, and a price calculator database and have the site return a list of products, the merchants where the products are sold, the initial pre coupon selling price, any available merchant coupons, and a final product price factoring in the initial starting price and any available coupon savings.

### BRIEF DESCRIPTION OF THE DRAWINGS

FIG. 1 depicts a block diagram of coupon integrator 100.

FIG. 2 depicts a block diagram of coupon integrator 100 using a categorical drill down.

FIG. 3 depicts a flow chart of price calculator model 148.

FIG. 4 depicts a flow chart of price calculator model 148 which accounts for percentage discount coupon 156.

FIG. 5 depicts a flow chart of current availability model 150.

FIG. 6 depicts a flow chart of shipping charge and tax inclusive model 170 using specific merchant coupon 126.

FIG. 7 depicts a flow chart of shipping charge and tax inclusive model 170 using percentage discount coupon 156.

Throughout the figures of the drawings, where the same part appears in more than one figure of the drawings, the same number is applied thereto.

### DESCRIPTION OF THE PREFERRED EMBODIMENTS

The main objective of this invention is to provide a system and method to quickly research online merchants that are selling a desired product, the pre coupon price of the desired product at each of these online merchants, any available coupons for the online merchant where the product is available, and the post coupon price of the product once the discount coupons have been factored into consideration.

This system is the coupon integrator of this invention. The coupon integrator provides this function by providing a website which allows the consumer to search or categorically drill down for the desired product and have the search or-categorical drill down be sent to a database of online merchants selling the product and a database of available coupons for those particular online merchants. The coupon integrator presents the information to the consumer so that he or she is able to quickly compare pre and post coupon prices at various online merchants. This procedure is applicable to searching or browsing as desired, and provides great utility.

Further modifications include a product availability database which determines if the product is currently available at a particular merchant. Also, a shipping charge and tax calculator database determines the final price after shipping, handling, and tax fees have and any shipping discount coupons have been factored into the price.

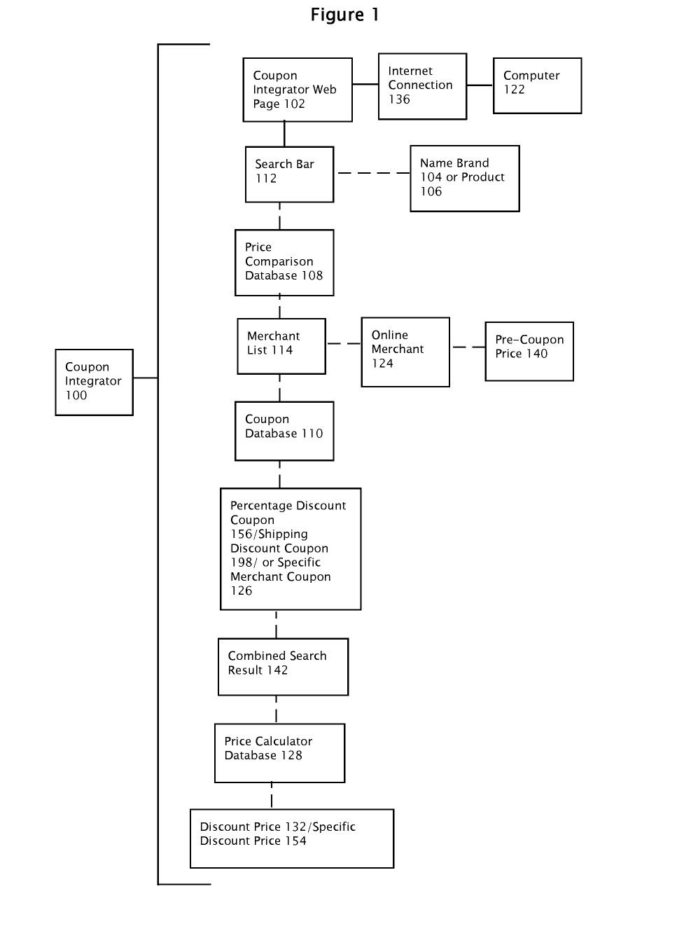

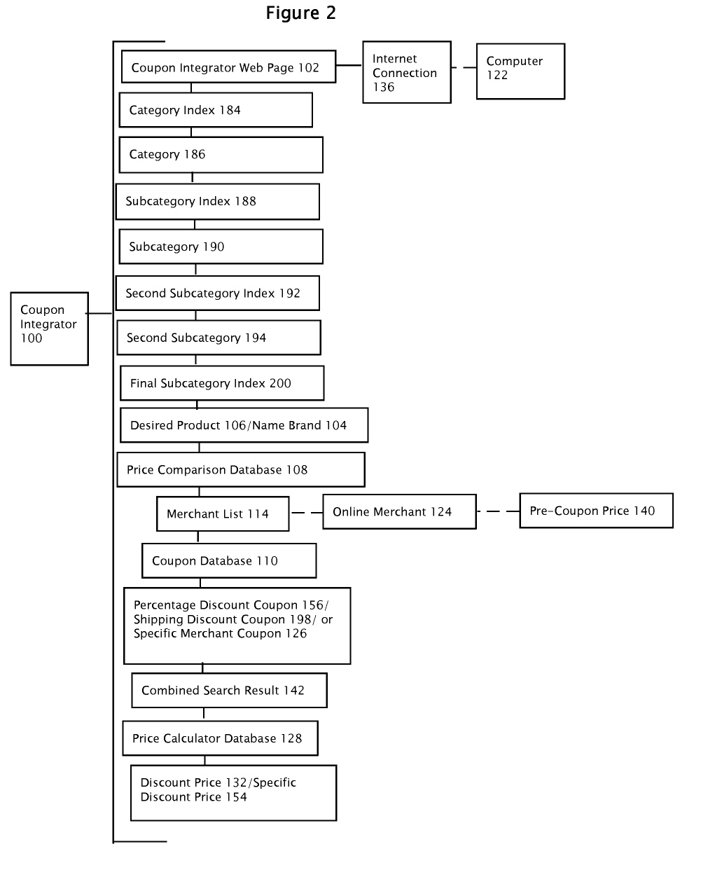

Considering now FIG. 1 and FIG. 2, the functionality of coupon integrator 100 can be seen. The user accesses the coupon integrator web page 102 through a computer 122 with internet connection 136. The consumer then has two different options. For the first option, the consumer types the name brand 104 or the desired product 106 in search bar 112.

For the second option, the consumer selects a desired category 186 from category index 184. Subcategory index 188 appears and the consumer selects the desired subcategory 190. Then, second subcategory index 192 appears. The consumer selects second subcategory 194. This narrowing process continues until no more subcategories exist and the consumer selects the desired product 106 or name brand 104 from final subcategory index 200.

Coupon integrator 100 uses the desired product 106 or name brand 104 to query price comparison database 108. Price comparison database 108 then identifies matching desired products 106 or name brands 104, the pre coupon price 140, and online merchants 124 which carry the desired product 106 or name brand 104. This consumer initiated query returns merchant list 114 which displays the online merchants 124 which carry the desired product 106 or name brand 104 and the pre coupon price 140.

Then, online merchant list 114 is used to query coupon database 110 for specific merchant or store coupons 126, percentage discount coupons 156, and shipping discount coupons 198. Coupon database 110 then returns combined search result 142.

Combined search result 142 displays online merchants carrying the desired product 106 or name brand 104, the pre coupon price 140 available at each online merchant 124, and specific merchant or store coupons 126, percentage discount coupons 156, and shipping discount coupons 198 redeemable for that online merchant 124. Then price calculator data base 128 is accessed, followed by a determination of discount price 132 or specific discount price 154.

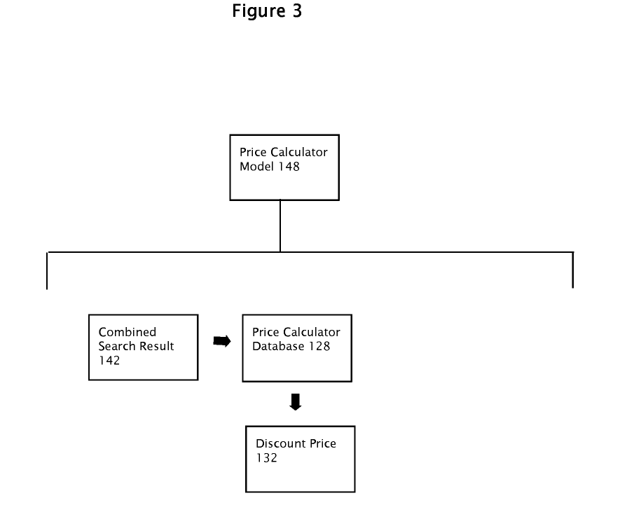

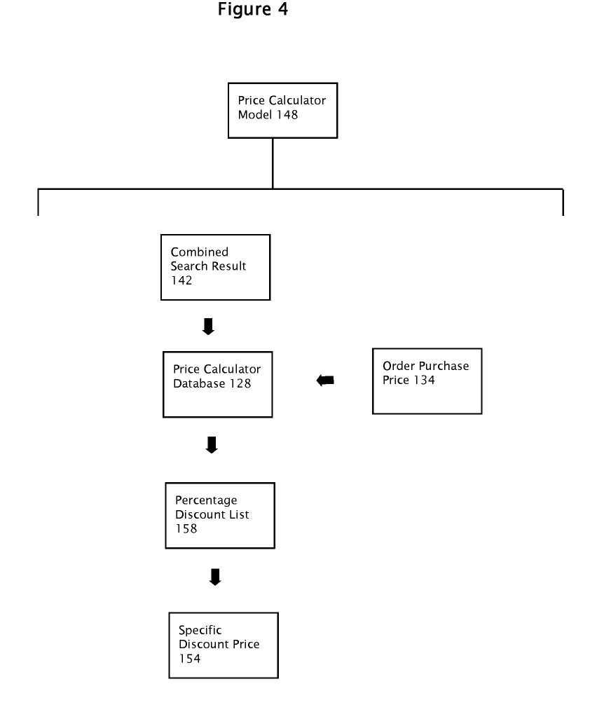

Adding FIG. 3 and FIG. 4 to the consideration, the functioning of optional, but preferred, price calculator model 148 can clearly be seen. In one embodiment, combined search result 142 is sent to price calculator database 128 which calculates discount price 132 for the particular name brand 104 or product 106, from a particular online merchant 124. The price calculator database 128 factors in the pre coupon price 140 and any specific merchant coupons 126 to achieve discount price 132.

A further embodiment of price calculator database 128 is to adapt its calculations based on order purchase price 134 to account for percentage discount coupons 156, which offer a percentage discount based on order purchase price 134. In this embodiment, combined search result 142, which has percentage discount coupons 156, and order purchase price 134 are entered into price calculator database 128. Then, price calculator database 128 returns a percentage discount list 158 which states specific discount price 154 based on order purchase price 134 and percentage discount coupons 156.

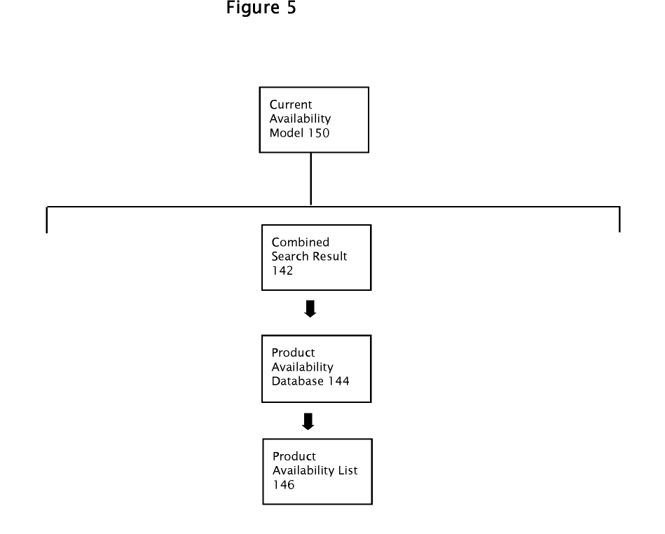

Adding FIG. 5 to the consideration, the function of optional current availability model 150 can be clearly seen. After combined search result 142 is sent to price calculator database 128, combined search result 142 is sent to product availability database 144. Product availability database 144 returns product availability list 146. Product availability list 146 shows whether a desired product 106 or name brand 104 is available at a particular online merchant 124 at the current time.

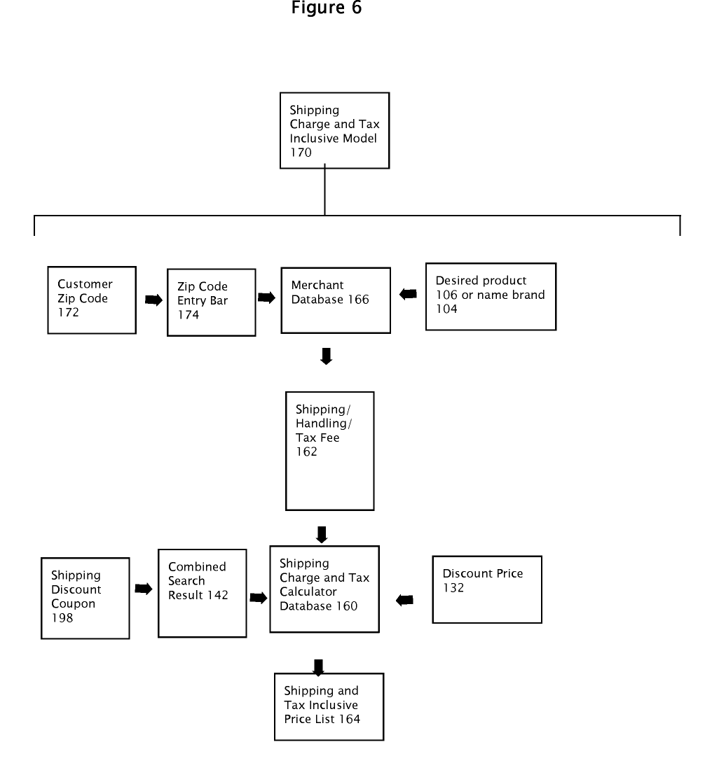

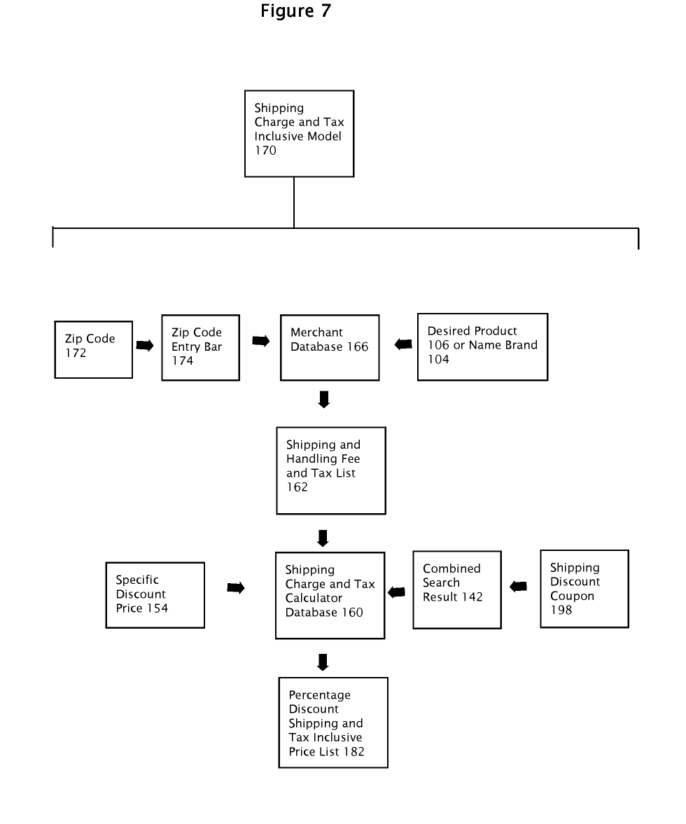

Adding FIG. 6 and FIG. 7 to consideration, the function of optional, but preferred, shipping charge and tax inclusive model 170 can be clearly seen. Coupon integrator web page 102 has an optional zip code entry bar 174. The desired name brand 104 or product 106 and the customer zip code 172 are used to query the merchant database 166. The merchant database 166 returns the shipping and handling and tax fee 162 for each online merchant 124 with the tax fee being a percent of the final order price such as the discount price 132 or the specific discount price 154.

The combined search result 142 and the shipping and handling and tax fee 162 are sent to shipping charge and tax calculator database 160. Shipping charge and tax calculator database 160 factors in shipping and handling and tax fee 162 for each particular online merchant 124 into the discount price 132. Shipping charge and tax calculator database 160 also factors in any shipping discount coupons 198 from the combined search result 142. Shipping charge and tax calculator database 160 then returns a shipping and tax inclusive price list 164.

For percentage discount coupons 156 based on an order purchase price 134, specific discount price 154 and the combined search result 142 are sent to shipping charge and tax calculator database 160. Shipping charge and tax calculator database 160 factors in shipping and handling and tax fee 162 for each specific discount price 154 with the tax fee being a percentage of the specific discount price 154. Shipping charge and tax calculator database 160 also factors in any shipping discount coupons 198 from combined search result 142. Shipping charge and tax calculator database 160 then returns a percentage discount shipping inclusive price list 182.

These databases are used selectively in any reasonable combination in order to find a good price for a consumer. This price may be interrelated to the actual receipt of the product by factoring in delivery costs, such as shipping costs.

This application—taken as a whole with the abstract, specification, claims, and drawings being combined—provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and device can become clear to a person having ordinary skill in this particular art. Such modifications are clearly covered by this disclosure.

What is claimed and sought to be protected by Letters Patent of the United States is:

1. A coupon integrator for searching for online coupons for a desired product or name brand comprising:
(a) the coupon integrator having a coupon integrator web page which is available through an internet connection;
(b) the coupon integrator web page having a search bar to accept either the desired product or the desired name brand or the coupon integrator web page having a categorical index capable of being categorically drilled down through a series of subcategories to the desired product or name brand;
(c) the coupon integrator having a price comparison database capable of accepting the desired product or name brand of at least one consumer;
(d) the price comparison database being capable of identifying matching products, pre coupon prices, and online merchants who carry the matching product;
(e) the price comparison database being capable of returning a merchant list which includes the pre coupon price of the product or name brand and online merchants who carry the product or name brand; and
(f) the coupon integrator having a coupon database capable of accepting the merchant list.

2. The coupon integrator of claim 1 further comprising:
(a) the coupon database being capable of returning a combined search result which contains the online merchants carrying the desired product or name brand, the pre coupon price available at each online merchant, and any available coupons for the particular online merchant;
(b) the coupon integrator containing a price calculator database which is capable of accepting the combined search result; and
(c) the price calculator database being capable of calculating a discount price based on the pre coupon price and factoring in the specific coupon available at the particular online merchant.

3. The coupon integrator of claim 1 further comprising:
(a) the coupon database being capable of returning a combined search result which contains the online merchants carrying the desired product or name brand, the pre coupon price available at each online merchant, and any available coupons for the particular online merchant;
(b) a price calculator database being capable of calculating a percentage discount price based on a specific order purchase price;
(c) the price calculator database being capable of calculating the percentage discount by factoring in the pre coupon price, the specific order purchase price and the percentage discount coupon; and
(d) the price calculator database being capable of returning a specific discount price based on its calculations.

4. The coupon integrator of claim 2 further comprising:
(a) the coupon integrator containing a product availability database which is capable of receiving the combined search result;
(b) the product availability database being capable of searching an availability of the desired product or name brand at each specific online merchant; and
(c) the product availability database being capable of returning a product availability list.

5. The coupon integrator of claim 4 further comprising:
(a) the coupon integrator containing a merchant database which is capable of receiving the desired product or name brand and a customer zip code;
(b) the merchant database being capable of searching a shipping and handling and tax fee for the desired product or name brand for each specific merchant; and
(c) the merchant database being capable of returning a shipping and handling and tax fee for the desired product or name brand for each specific merchant.

6. The coupon integrator of claim 5 further comprising:
(a) the coupon integrator containing a shipping charge calculator database which is capable of receiving the combined search result, the discount price, and the shipping and handling and tax fee;
(b) the shipping charge calculator database being capable of calculating a shipping and tax inclusive price list by factoring in a shipping discount coupon, if any are available, and the discount price for at least one particular online merchant; and
(c) the shipping charge calculator database being capable of returning the shipping and tax inclusive price based on its calculations.

7. The coupon integrator of claim 3 further comprising:
(a) the coupon integrator containing a product availability database which is capable of receiving the combined search result;
(b) the product availability database being capable of searching the availability of the desired product or name brand at each specific online merchant; and
(c) the product availability database being capable of returning a product availability list.

8. The coupon integrator of claim 7 further comprising:
(a) the coupon integrator containing a merchant database which is capable of receiving the desired product or name brand and a customer zip code;
(b) the merchant database being capable of searching a shipping and handling and tax fee for the desired product or name brand; and
(c) the merchant database being capable of returning a shipping and handling and tax fee for the desired product or name brand for each specific merchant.

9. The coupon integrator of claim 8 further comprising:
(a) the coupon integrator containing the shipping charge calculator database which is capable of receiving the combined search result and the shipping and handling and tax fee, and the specific discount price;
(b) the shipping charge calculator database being capable of calculating a percentage discount shipping and tax inclusive price list by factoring in a shipping discount coupon, if any are available, and the specific discount price for at least one particular online merchant; and
(c) the shipping charge calculator database being capable of returning a shipping inclusive price based on its calculations.

10. A method for searching for online coupons for a desired product or name brand comprising:
(a) providing a coupon integrator which is accessible through a coupon integrator web page;
(b) providing the coupon integrator web page which is accessible through an internet connection;
(c) providing a search bar on the coupon integrator web page or providing a categorical index of products;
(d) typing in the name of a desired product or name brand in the search bar or categorically drilling down the categorical index through a series of categories and subcategories until the desired product or name brand is reached;
(e) querying a price comparison database with the desired product or name brand which returns a merchant list; and
(f) querying a coupon database with the merchant list which returns a combined search result.

11. The method of claim 10 further comprising:
(a) querying a price calculator database with the combined search result; and
(b) calculating a discount price using the price calculator database.

12. The method of claim 10 further comprising:
(a) querying a price calculator database with the combined search result, a percentage discount coupon, and a order purchase price; and
(b) calculating a percentage discount price using the price calculator database.

13. The method of claim 11 further comprising:
(a) querying a product availability database with the combined search result which returns a product availability list.

14. The method of claim 13 further comprising:
(a) querying a merchant database with the desired product or name brand and a customer zip code which returns a shipping and handling and tax fee.

15. The method of claim 14 further comprising:
(a) querying the shipping charge calculator database with the combined search result, the discount price, and the shipping and handling and tax fee; and
(b) calculating and returning a shipping and handling and tax inclusive price list.

16. The method of claim 12 further comprising:
(a) querying a product availability database with the combined search result which returns a product availability list.

17. The method of claim 16 further comprising:
(a) querying a merchant database with the desired product or name brand and a customer zip code which returns a shipping and handling and tax fee.

18. The method of claim 17 further comprising:
(a) querying the shipping charge calculator database with the combined search result, and the specific discount price, and the shipping and handling and tax fee; and
(b) calculating and returning a shipping and handling and tax inclusive price list.
